(19) United States
(12) Patent Application Publication
(10) Pub. No.: US 2007/0052118 A1
(43) Pub. Date: Mar. 8, 2007

(54) Method of fabricating optical film

(75) Inventors: Junichiro Kudo, Tokyo (JP); Akira Sannai, Tokyo (JP); Takashi Abe, Miyagi (JP); Yoshiyuki Kubota, Tokyo (JP)

Correspondence Address: BELL, BOYD & LLOYD, LLC, P. O. BOX 1135, CHICAGO, IL, 60690-1135, US

(73) Assignee: Sony Corporation, Tokyo (JP)

(21) Appl. No.: 11/470,106

(22) Filed: Sep. 5, 2006

(30) Foreign Application Priority Data
Sep. 5, 2005 (JP) P2005-256709
Aug. 3, 2006 (JP) P2006-212079

(51) Int. Cl. B29D 11/00

(52) U.S. Cl. 264/1.6; 264/2.7

(57) ABSTRACT

A method of fabricating an optical film is provided. The method includes nipping a film composed of a molten polycarbonate resin extruded in a film-forming manner from a die attached to an extruder, between a temperature-preset molding roll having an engraving pattern on the surface thereof and a temperature-preset elastic roll, and thereby transferring the engraving pattern onto the film; and allowing the film having the engraving pattern transferred thereon to travel around the molding roll, and then separating the film from the molding roll. In the method, a preset value of a surface temperature of the molding roll is adjusted within a range of Tg+20° C. or above and Tg+45° C. or below, where Tg is a glass transition temperature of the film, and a preset value of a surface temperature of the elastic roll is adjusted to Tg or below.

### CROSS REFERENCES TO RELATED APPLICATIONS

The present application claims priority to Japanese Patent Application JP 2005-256709 and JP 2006-212079 filed in the Japanese Patent Office on Sep. 5, 2005 and Aug. 3, 2006, respectively, the entire contents of which being incorporated herein by reference.

### BACKGROUND

The present disclosure relates to a method of fabricating an optical film suitably applicable, for example, to liquid crystal display device.

In recent years, demands for higher luminance, wider viewing angle, and larger contrast have been becoming more stringent in the field of liquid crystal display device, and consequently roles of optical film have increasingly been adding their importance. There are various known methods of fabricating an optical film, and among others, the molten extrusion method and the hot press method are widely known.

The molten extrusion method fabricates an optical film by extruding a molten resin from a die attached to an extruder, and nipping the resin using a pair of rolls. The hot press method fabricates the optical film by pressing a sheet under heating between a die having a pre-embossed pattern over the entire surface thereof and a die having a flat surface.

There has also been proposed, in these molten extrusion method and hot press method, a technique of controlling a die temperature during the film formation, in view of improving optical characteristics of the optical film. Known methods of controlling the die temperature, and of improving the ratio of transferability include the followings.

Japanese Patent Publication No. 3308733 (p. 3, paragraph [0017]) describes the molten extrusion method by which an optical film is fabricated by nipping a resin, extruded from a T-die, between a die roll and a rubber roll, while keeping the internal temperature of the die roll at 150° C.

Japanese Patent Publication No. 3607759 (p. 7, paragraph [0026]) describes the hot press method by which an optical film is fabricated by keeping a die at a temperature of 250° C. and a pressure of 100 Kg/cm² for 15 minutes, and then by cooling the die to normal temperature.

Japanese Patent Application Publication “KOKAI” No. 2003-185844 (p. 2, Claim 3) describes the molten extrusion method in which, when a film composed of an amorphous thermoplastic resin extruded as a film from a die is brought into close contact with a cooling roll, the resin temperature immediately after being extruded from the die is adjusted to Tg+130° C. or above, and the temperature of the film under travel from an outlet of the die up to the contact point with the cooling roll is kept so as not to fall below Tg+100° C.

Japanese Patent Application Publication “KOKAI” No. 2000-280268 (p. 2, Claim 1) describes a method of fabricating an optical sheet allowing a metal endless belt to pass through a metal cast drum and a drive roller, and temperatures of a metal cast drum and a drive roller are respectively set to Tg+50° C. or below, to thereby effect molten extrusion.

The method described in Japanese Patent Publication No. 3308733 (p. 3, paragraph [0017]) can successfully enhance the transferability, but suffers from a problem in that some kinds of resin may tend to cause sticking. Efforts of lowering the temperature of the die roll in view of suppressing the sticking may, however, degrade the transferability. That is, it has long been believed as difficult to achieve desirable levels of transferability and mold releasability at the same time by the related art methods.

The method described in Japanese Patent Publication No. 3607759 (p. 7, paragraph [0026]) raises a problem of degradation of the productivity, because it is necessary to lower the die temperature to a degree allowing the separation. The method described in Japanese Patent Application Publication “KOKAI” No. 2003-185844 (p. 2, Claim 3) raises a problem of shortening of service life of the die, and also raises difficulty in ensuring a necessary level of mechanical accuracy, because the die is heated to high temperatures. The method described in Japanese Patent Application Publication “KOKAI” No. 2000-280268 (p. 2, Claim 1) raises a problem in that geometrical decay tends to occur at temperatures close to the upper limit due to thermal stress relaxation.

As described in the above, there have been strong needs for a method of fabricating an optical film capable of providing a high-quality optical film, ensuring desirable levels of transferability and mold releasability at the same time, without causing any degradation in the productivity and shortening of service life of die.

Polycarbonate resin is widely used as a resin material suitable for this sort of optical film. The polycarbonate resin becomes more likely to stick on the molding roll at a molding temperature above the glass transition point (Tg: approximately 145° C.) by its nature, and thereby produces a separation mark on the film as a result of non-smooth separation. On the other hand, lowering of the molding temperature below Tg, aiming at improving the mold releasability, raises another problem of degradation in the transferability such that a desired engraving pattern cannot be transferred onto the film with a high accuracy.

### SUMMARY

The present disclosure is aimed at providing a high-quality optical film composed of polycarbonate resin, ensuring desirable levels of transferability and mold releasability at the same time.

In general, the polycarbonate resin is sharply degraded in the mold releasability above its glass transition point (Tg). On the other hand, the present disclosure relates to a temperature range, even above Tg, in which the mold releasability restores.

A method of fabricating an optical film according to an embodiment includes nipping a film which is composed of a molten polycarbonate resin extruded in a film-forming manner from a die attached to an extruder, between a temperature-preset molding roll having an engraving pattern on the surface thereof and a temperature-preset elastic roll, and thereby transferring the engraving pattern onto the film; and allowing the film having the engraving pattern transferred thereon to travel around the molding roll, and then separating the film from the molding roll. In the method, a preset value of a surface temperature of the molding roll is adjusted within the range from Tg+20° C. or above and Tg+45° C. or below, where Tg is the glass transition temperature of the film, and a preset value of a surface temperature of the elastic roll is adjusted to Tg or below.

In an embodiment, the mold releasability of the film is improved by adjusting a preset value of the surface temperature of the molding roll within the range from Tg+20° C. or above and Tg+45° C. or below, to thereby prevent the separation mark as a result of sticking of the film onto the molding roll from occurring. Because a preset value of the surface temperature of the elastic roll in this process is adjusted to Tg or below, the molded film is successfully prevented from sticking onto the elastic roll. Because the film is molded at high resin temperatures above Tg, accuracy in transfer of the engraving pattern can be improved.

The film may be separated between the molding roll and the temperature-preset cooling roll in contact with the molding roll while placing the film in between, and a preset value of the surface temperature of the cooling roll is adjusted to Tg or below. In an alternate process, the film is separated between the molding roll and the temperature-preset cooling roll kept in non-contact with the molding roll, and a preset value of the surface temperature of the cooling roll is adjusted to Tg or below.

A method of fabricating an optical film according to another embodiment includes nipping a film which is composed of a molten polycarbonate resin extruded in a film-forming manner from a die attached to an extruder, between a temperature-preset molding roll having an engraving pattern on the surface thereof and a temperature-preset elastic roll, and thereby transferring the engraving pattern onto the film; and allowing the film having the engraving pattern transferred thereon to travel around the elastic roll, and then separating the film from the elastic roll. In the method, a preset value of a surface temperature of the molding roll is adjusted within a range of Tg+20° C. or above and Tg+45° C. or below, where Tg is the glass transition temperature of the film, and a preset value of a surface temperature of the elastic roll is adjusted to Tg or below.

According to the embodiments, the engraving pattern can successfully be transferred onto the film composed of polycarbonate resin, while preventing the sticking onto the molding roll, by nipping the film between the molding roll having the surface temperature preset within the range from Tg+20° C. or above and Tg+45° C., and the elastic roll having the surface temperature preset to Tg or below. By setting the surface temperature of the elastic roll to Tg or below, the sticking of the film onto the elastic roll can be suppressed.

As has been described above, the present embodiments can transfer the engraving pattern onto a film composed of polycarbonate resin, and can suppress sticking of the film. The transferability and the mold releasability can thus be achieved at the same time.

### BRIEF DESCRIPTION OF THE FIGURES

FIG. 1 is a perspective view showing an exemplary optical film fabricated by a method of fabricating an optical film according to an embodiment;

FIG. 2 is a schematic drawing showing an exemplary configuration of an extrusion sheet precision molding apparatus used for a method of fabricating an optical film according to a first embodiment;

FIG. 3 is a perspective view schematically showing an exemplary configuration of the extrusion sheet precision molding apparatus used for the method of fabricating an optical film according to the first embodiment;

FIG. 4 is a graph showing exemplary time-dependent changes in the resin temperature over a period during which the molten polycarbonate resin extruded from a die, and is molded to yield a film;

FIG. 5 is a graph showing exemplary time-dependent changes in the surface temperature of a molding roll over a period during which the molten polycarbonate resin is brought into contact with the molding roll, and is then separated therefrom;

FIG. 6 is a schematic drawing showing an exemplary configuration of an extrusion sheet precision molding apparatus used for the method of fabricating an optical film according to a second embodiment;

FIG. 7 is a schematic drawing showing an exemplary configuration of an extrusion sheet precision molding apparatus used for the method of fabricating an optical film according to a third embodiment; and

FIG. 8 is a sectional view showing configurations of the molding roll and the elastic roll explained in the embodiment.

### DETAILED DESCRIPTION

Paragraphs below will describe the individual embodiments, referring to the attached drawings. In all drawings showing the embodiments below, any similar or corresponding components will be given with the same reference numerals.

### First Embodiment

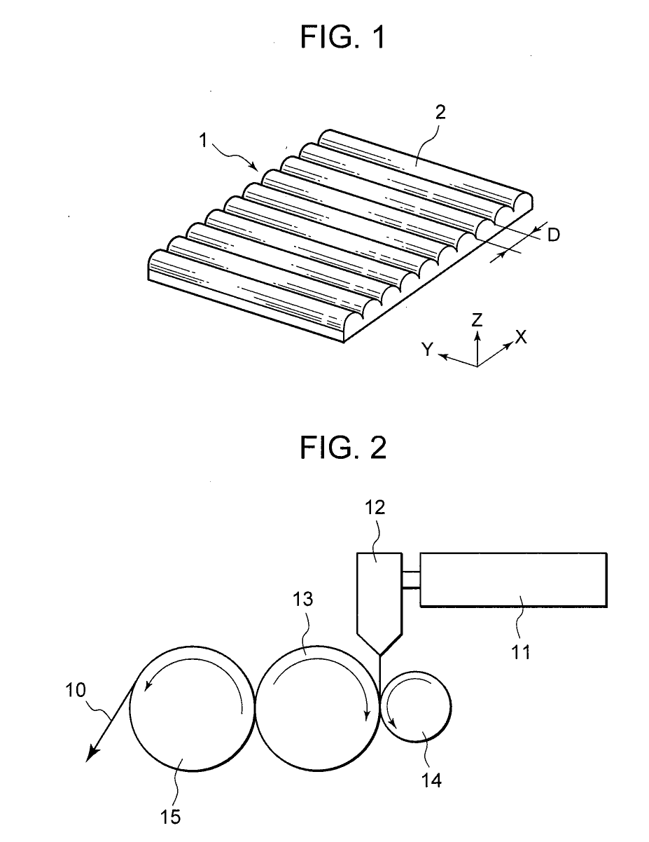

FIG. 1 is a perspective view showing an exemplary optical film fabricated by a method of fabricating an optical film according to a first embodiment. The optical film 1 has a rectangular form as a whole in a plan view, and is applicable to an optical film for liquid crystal display devices, for example.

The optical film 1 has a flat surface on the side of incidence of light from a light source (the lower surface in FIG. 1). On the surface on the side the light from the light source is emitted (the upper surface in FIG. 1), a number of laterally symmetrical higher-order aspherical toroidal lens components (or lenticular lens components) 2 are consecutively provided in a direction perpendicular to a generatrix of the aspherical surface. Each toroidal lens component 2 has a single focal length on the side the light from the light source is emitted. Assumption is now made, as shown in FIG. 1, such that X-axis aligns in parallel with the direction of row of the toroidal lens components 2, Y-axis aligns in parallel with the direction of generatrix of the toroidal lens component 2, and Z-axis aligns in parallel with the direction of normal line on the optical film.

The width of the toroidal lens component 2, or the width D of a unit constituent, is selected from the range of 10 μm or more and 500 μm or less, and is selected to 50 μm, for example. The optical film 1 is provided between a diffusion sheet and a liquid crystal panel, so that the surface having the plurality of toroidal lens components 2 provided thereon is opposed to the liquid crystal panel, for example. An X-Z sectional geometry of the toroidal lens component 2 is typically expressed by any one of the equations (1) to (3) below:
Z=X²/(R+√(R²−(1+K)X²))+AX⁴+BX⁵+CX⁶⁺ (1)
where R is radius of curvature at the apex of the toroidal lens component 2, K is a conic coefficient, and A, B, C are aspherical coefficients.

It should be noted that, in the present disclosure, the sign “√” is used to obtain a square root of a value obtained in the mathematical expression following the sign.

In the equation (1), relations of 0<R<20, −15<K<−1, 0<A, B, C<10⁻³, or relations of R≧0, K<−1, R−K≧5, 0<A<10⁻³, O≦B, <10⁻³ are preferred. By making selection within these numerical ranges, directivity of illumination light and viewing angle are successfully improved.
Z=X²/(R√(R²−(1+K)X²) (2)

where, R is radius of curvature at the apex of the toroidal lens component 2, and K is a conic coefficient.

In the equation (2), relations of 0<R<50 and −4<K<−1 are preferred.
Z=X²/2R (3)

where, R is radius of curvature at the apex of the toroidal lens component 2.

In the equation (3), a relation of 1<D/R<10 is preferred.

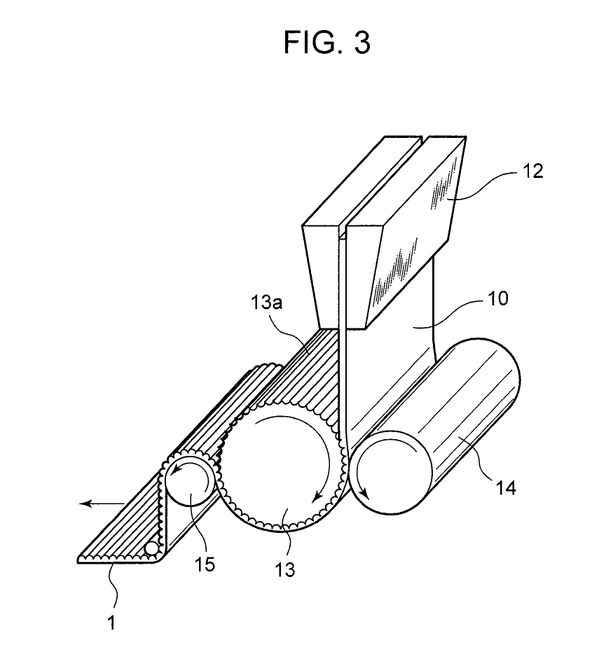

FIG. 2 and FIG. 3 are schematic drawings showing an exemplary configuration of an extrusion sheet precision molding apparatus used for the method of fabricating an optical film according to this embodiment. The extrusion sheet precision molding apparatus has an extruder 11, a T-die 12, a molding roll 13, an elastic roll 14 and a cooling roll 15.

Polycarbonate (PC) is used herein as a resin material used for molding the optical film 1, and has a glass transition point (Tg) of 145° C.

The extruder 11 fuses the resin material fed through a hopper, not shown, and supplies it to the T-die 12. The T-die 12 has a straight-linear opening, and discharges therethrough the resin material supplied from the extruder 11, while spreading it to as wide as a desired sheet width.

The molding roll 13 has a cylindrical form, and is configured as rotatable around its center axis assumed as the axis of rotation. The molding roll 13 is also configured to be capable of being cooled. More specifically, the molding roll 13 has one or more fluid passageways allowing a coolant to flow therethrough. An oil medium, for example, may be used as the coolant, and the temperature of the coolant is varied within the temperature range from 120° C. to 230° C., for example, using an unillustrated temperature regulator or the like, to thereby preset the surface temperature of the molding roll 13 within the range from Tg+20° C. or above and Tg+45° C. or below.

The molding roll 13 has provided on the cylindrical surface thereof an engraving pattern 13a (FIG. 3) used for transferring a fine pattern onto the film (or sheet) discharged from the T-die 12 to be molded. The engraving pattern is, for example, a fine irregurality (emboss) used for transferring the toroidal lenses onto a film 10. The irregularity is formed by precision cutting using a diamond cutting tool, for example. In this embodiment, the engraving pattern is formed on the molding roll 13 so as to align the X-axis direction of the optical film 1 shown in FIG. 1 to the circumferential direction of the molding roll 13, and so as to align the Y-axis of the optical film 1 to the height-wise direction (axial direction) of the molding roll 13.

The elastic roll 14 has a cylindrical form, and is configured to be rotatable around its center axis assumed as the axis of rotation. The surface of the elastic roll 14 is configured to be elastically deformable, so that the surface brought into contact with the molding roll 13 can be depressed, when the sheet is nipped between the molding roll 13 and the elastic roll 14.

The elastic roll 14 may be, as described later, covered with a seamless cylinder composed of Ni plating or the like, for example, and has, inside thereof, an elastic component allowing the surface of the elastic roll 14 to cause elastic deformation. There are no special limitations on the configuration and constitutive materials of the elastic roll 14, so far as it is configured with such elastic component wrapping around the circumference of a metal roll, and so far as it can cause elastic deformation on the surface thereof when brought into contact with the molding roll 13 under a predetermined pressure. The constitutive materials adoptable herein include rubber materials, metals, composite materials and the like. The elastic roll 14 adoptable herein is not limited to the roll-type one, but may be the sleeve-like or belt-type one.

The elastic roll 14 is configured to be capable of being cooled. More specifically, the elastic roll 14 has one or more fluid passageways allowing a coolant to flow therethrough. Water can typically be used as the coolant, and the base temperatures thereof are set typically to 80° C. and 130° C., using an unillustrated pressurized-water-warmer-type temperature regulator, to thereby preset the surface temperature of the elastic roll 14 to Tg or below. The temperature regulator may be oil-based.

Surface pressure between the molding roll 13 and the elastic roll 14 can arbitrarily be set. The surface pressure between the molding roll 13 and the elastic roll 14 may be regulated by a surface pressure regulating mechanism energizing the axis of rotation of the elastic roll 14 towards the molding roll 13 side. The surface pressure regulating mechanism can typically be composed of a pressurizing cylinder, and the surface pressure can arbitrarily be set by regulating driving force of the pressurizing cylinder.

The cooling roll 15 has a cylindrical form, and is brought into contact with the molding roll 13 while placing the film 10 in between. The cooling roll 15 is configured as rotatable around its center axis assumed as the axis of rotation. The cooling roll 15 is configured to be capable of being cooled. More specifically, the cooling roll 15 has one or more fluid passageways allowing a coolant to flow therethrough. Water can be used as the coolant, for example. The surface temperature of the cooling roll 15 is set to Tg or below, for example, to 115° C., using an unillustrated pressurized-water-warmer-type temperature regulator. The temperature regulator may be of oil-base.

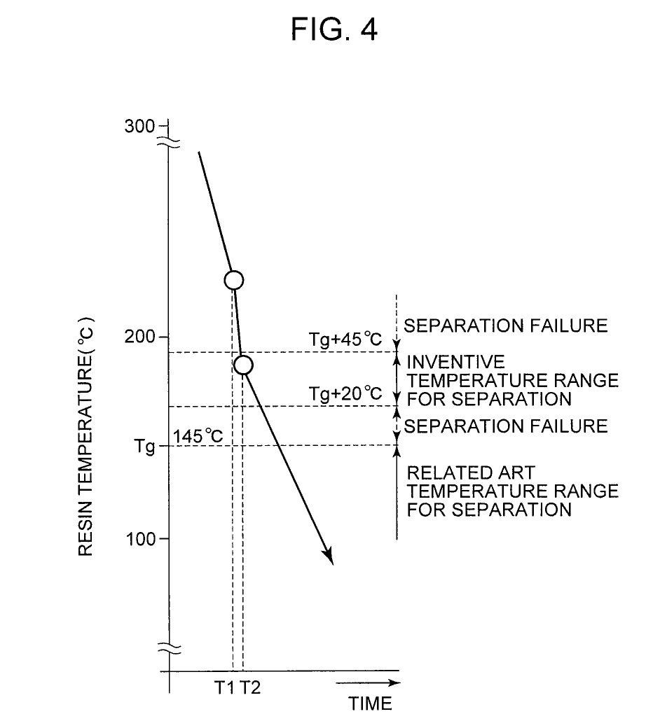

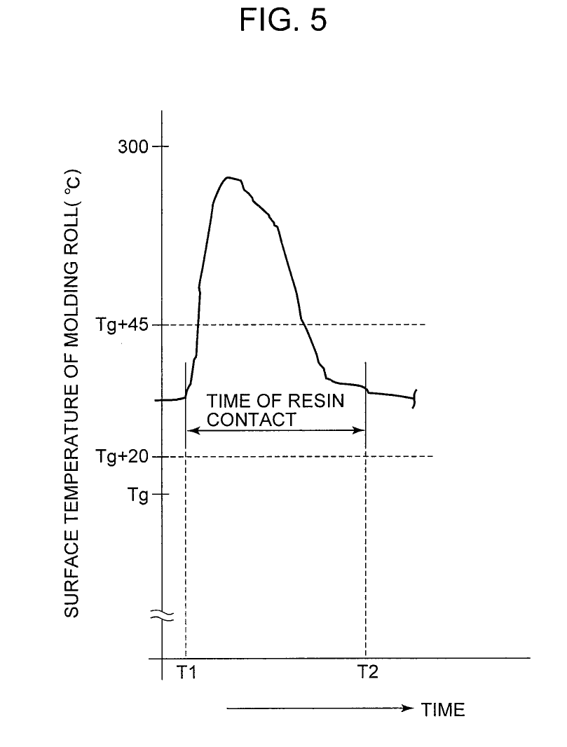

Paragraphs below will explain the method of fabricating an optical film according to the first embodiment. FIG. 4 shows exemplary time-dependent changes in the resin temperature over a period during which the molten polycarbonate resin extruded from the T-die 12, and is molded to yield a film. FIG. 5 shows exemplary time-dependent changes in the surface temperature of the molding roll 13 over a period during which the molten polycarbonate resin is brought into contact therewith.

First, the resin material is fused in the extruder 11, then successively fed to the T-die 12, and is discharged from the T-die 12 in a consecutive manner.

The film 10 composed of a molten polycarbonate resin, extruded from the T-die 12 in a film-forming manner at time T1 is then held under pressure (nipped) between the molding roll 13 and the elastic roll 14. By this process, the engraving pattern 13a on the molding roll 13 is transferred onto the film 10.

In this process, as shown in FIG. 5, the surface temperature of the molding roll 13 sharply elevates in the initial stage of contact with the polycarbonate resin, but is cooled, after elapse of a predetermined duration of time, to a surface temperature preset within the range from Tg+20° C. or above and Tg+45° C. or below (165° C. or above and 190° C. or below). The predetermined duration of time herein corresponds to a duration of time (from T1 to T2) up to separation of the film 10 from the molding roll 13, and determination is made on molten resin temperature, feed speed of the film 10 (rotational speed of the molding roll 13), diameter of the molding roll 13, the preset surface temperature of the elastic roll 14 and the like, so that the surface temperature of the molding roll 13 can be restored within the above-described temperature range during the above-described duration of time. The preset value of the surface temperature of the elastic roll 14 is adjusted to Tg as described in the above. The lower limit of the temperature of the elastic roll 14 is not specifically limited, and may be set to 20° C. or above, for example.

By keeping the surface temperature of the molding roll 13 and the elastic roll 14 within the above-described ranges, the engraving pattern 13a can be transferred onto the film 10 in a successful manner. The temperature of the film 10 (resin temperature at time T1) in the process of transferring the engraving pattern 13a is preferably set within the range from Tg+50° C. to Tg+230° C., and more preferably from Tg+80° C. to Tg+200° C. By keeping the temperature of the film 10 within the above-described ranges, the engraving pattern 13a can be transferred onto the film 10 in a successful manner.

The film 10 having the engraving pattern transferred thereon is allowed to travel around the molding roll 13, and is then separated from the molding roll 13 at time T2 with the aid of the cooling roll 15. The temperature of the film 10 in the process of separation thereof from the molding roll 13 is adjusted within the range of Tg+20° C. or above and Tg+45° C. or below. The surface temperature of the cooling roll 15 is preset to Tg or below. By setting the surface temperature of the cooling roll 15 within the above-described temperature range, and by suppressing flapping of the film 10 by nipping it between the molding roll 13 and the cooling roll 15, the film 10 can be separated from the molding roll 13 in a successful manner.

As has been described in the above, the surface temperature of the molding roll 13 in this embodiment is preset within the range of Tg+20° C. or above and Tg+45° C. or below. Assuming now, for explanation, that the surface temperature of the molding roll 13 and the resin temperature are the same, the film 10 is separated from the surface of the molding roll 13 while keeping the temperature thereof within the range of Tg+20° C. or above and Tg+45° C. or below. As shown in FIG. 4, the polycarbonate resin has a temperature range above Tg in which the mold releasability can be restored. This temperature range corresponds to the range of Tg+20° C. or above and Tg+45° C. or below. Because the transferability improves as the resin temperature rises, the above-described temperature range can improve accuracy in the transfer while keeping a desirable level of separability of the film.

In this way, the long film 10 having the engraving pattern 13a on the molding roll 13 transferred thereon is fabricated. Cutting of thus-fabricated film 10 to a predetermined size can produce the optical film 1 having the toroidal lens components 2 formed on one surface thereof as shown in FIG. 1.

Effects explained below can be obtained by the first embodiment.

The preset value of the surface temperature of the molding roll 13 is adjusted within the range of Tg+20° C. or above and Tg+45° C. or below, and the preset value of the surface temperature of the elastic roll 14 is adjusted to Tg or below (20° C. or above), so that the film 10 having a predetermined engraving pattern accurately transferred thereon can be fabricated, without producing the separation mark as a result of sticking of the film 10 onto the molding roll 13 and the elastic roll 14.

The preset value of the surface temperature of the cooling roll 15 is adjusted to Tg or below, so that geometrical changes of the film 10 over a period in which the film is cooled can be suppressed. In addition, the film 10 is separated between the molding roll 13 and the cooling roll 15 brought into contact therewith while placing the film 10 in between, so that the film 10 can smoothly be separated from the molding roll 13, and thereby the separation mark can effectively be prevented from occurring on the film 10. It is also made possible to suppress waviness of the film 10.

### Second Embodiment

Paragraphs below will describe a second embodiment.

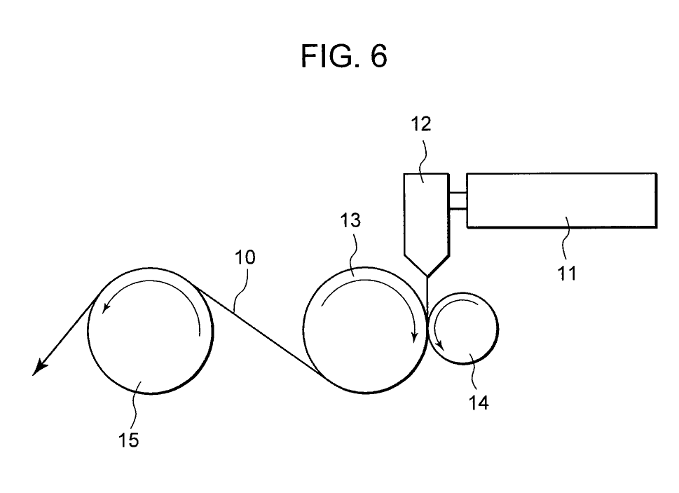

FIG. 6 is a schematic drawing showing an exemplary configuration of an extrusion sheet precision molding apparatus used for the method of fabricating an optical film according to the second embodiment. In this embodiment, as shown in FIG. 6, the film is separated from the molding roll 13, while keeping a predetermined distance between the molding roll 13 and the cooling roll 15 so as to ensure non-contactness therebetween.

Other aspects of the configuration are same as described above in the first embodiment. This embodiment can also achieve desirable levels of the separability and the transferability comparable to those in the first embodiment described in the above.

### Third Embodiment

Paragraphs below will describe a third embodiment.

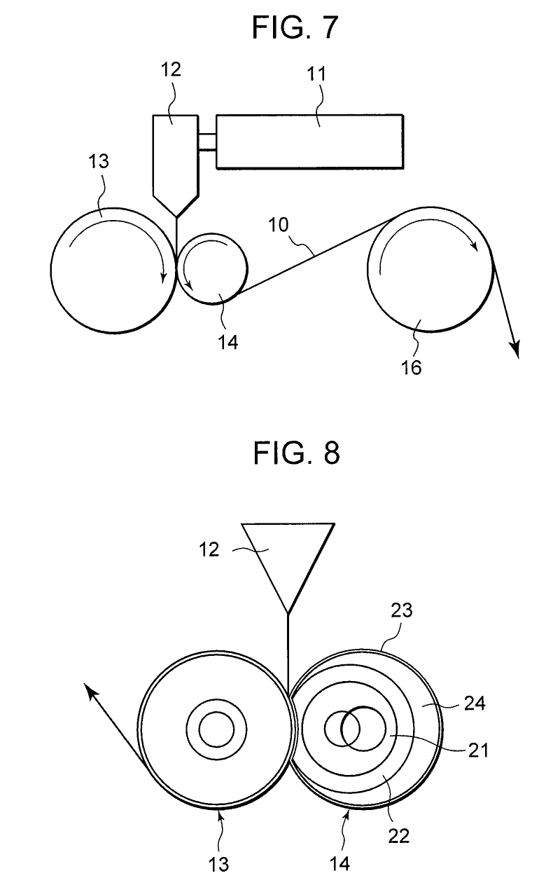

FIG. 7 is a schematic drawing showing an exemplary configuration of an extrusion sheet precision molding apparatus used for the method of fabricating an optical film according to the third embodiment. The extrusion sheet precision molding apparatus has the extruder 11, the T-die 12, the molding roll 13, the elastic roll 14 and a guide roll 16.

In the third embodiment, as shown in FIG. 7, the film 10 is allowed to travel around the elastic roll 14, and is then separated between the elastic roll 14 and the guide roll 16. The guide roll 16 has a cylindrical form, and is configured as rotatable around its center axis assumed as the axis of rotation. The guide roll 16 is disposed a predetermined distance apart from the elastic roll 14. The guide roll 16 is configured to be capable of being cooled. More specifically, the guide roll 16 has one or more fluid passageways allowing a coolant to flow therethrough. Water or oil can be used as the coolant, for example.

Other aspects of the configuration are same as described above in the first embodiment. This embodiment can also obtain operations and effects similar to those in the first embodiment described in the above. In particular, this embodiment can make the separation mark less likely to occur on the film 10, and is therefore suitable for fabrication of thin film.

### EXAMPLES

Paragraphs below will specifically describe the embodiments with reference to Examples, without limiting the present invention to these examples.

In the following description, a roll type allowing the molding roll 13 and the cooling roll 15 to contact while placing the film 10 in between, as shown in FIG. 2, will be referred to as “Type-1”. A roll type having the molding roll 13 and the cooling roll 15 spaced from each other, and setting the film 10 free after being separated from the molding roll 13, as shown in FIG. 6, will be referred to as “Type-2”. A roll type nipping the film 10 between the molding roll 13 and the elastic roll 14, and is then allowing the film 10 to wrap around on the elastic roll 14 side, as shown in FIG. 7, will be referred to as “Type-3”.

Examples 1 to 3, and Comparative Examples 1 and 2 adopt “Type-1” as the roll type, wherein the preset value of the surface temperature of the molding roll 13 is varied while keeping the surface temperature of the elastic roll 14 at a constant preset temperature. Examples 4 and 5, and Comparative Examples 3 and 4 adopt “Type-2” as the roll type, wherein the preset value of the surface temperature of the elastic roll 14 is varied while keeping the surface temperature of the molding roll 13 at a constant preset temperature. Examples 6 and 7 adopt “Type-2” and “Type-3”, respectively, as the roll type, wherein the preset value of the surface temperature of the molding roll 13 and the elastic roll 14 is kept at a constant preset temperature. Comparative Example 5 adopts “Type-1” as the roll type, while varying the preset value of the surface temperature of the cooling roll 15.

### Example 1

First, an extrusion sheet precision molding apparatus used for fabricating sample optical films of Examples and Comparative Examples will be explained. FIG. 8 is a sectional view showing a configuration of the molding roll 13 and the elastic roll 14.

The elastic roll 14 is configured to have an elastic component 22 affixed on a roll 21 allowing a cooling medium to flow therethrough, and is further covered with a flexible sleeve 23 which is a seamless cylinder. A circulation space allowing a cooling water 24 to flow therethrough is formed between the elastic component 22 and the flexible sleeve 23. The flexible sleeve 23 is 340 μm thick, and is fabricated by forming a seamless cylinder by Ni plating, further subjecting the cylinder to chromium (Cr) plating, and then polishing the product so as to achieve a surface roughness of 0.2 S.

The elastic component 24 herein was formed using nitrile rubber (NBR) having a hardness of 85, and a thickness of 20 mm. The diameter of the elastic roll 14 herein was 260 mm, and the length of surface (width of the molding roll) was 450 mm. The molding roll 13 was configured as allowing the coolant to flow therethrough in a plurality of fluid passageways, in view of minimizing non-uniformity in the temperature distribution. A material used herein was S45C, processed by quench-and-temper, mirror-polishing (0.5 S or below), and subjecting it to electroless NiP (nickel-phosphorus) plating (100 μm thick).

The engraving pattern provided on the cylindrical surface of the molding roll 13 was formed as described below. First, the molding roll was placed on a ultra-precision lathe housed in a thermostat-hygrostat room (temperature 23° C., humidity 50%), and a diamond cutting tool having a predetermined geometry (angle of divergence of 92°, with a rounded apex) was set. Grooves of 60 μm deep were then formed at a 90 μm pitch, in the circumferential direction of the molding roll 13. The grooves were formed as recesses having an angle of divergence of 92°, and as being rounded at the bottom of the recesses. The molding roll 13 is 300 mm in diameter, 460 mm in length of surface, and 300 mm in groove forming width.

An oil medium was used as the coolant of the molding roll 13. Water was used as the coolant for the elastic roll 14 and the cooling roll 15, and the temperature of the coolant was regulated using a pressurized-water-warmer-type temperature regulator.

The extruder 11 adopted herein was such as having a vented screw of 50 mm in diameter, and having no gear pump. The T-die 12 adopted herein was a coat-hanger die, having a lip width of 550 mm and a lip gap of 1.5 mm. The air gap was set to 105 mm.

The optical film was molded using the extrusion sheet precision molding apparatus configured as described in the above. First, polycarbonate E2000R (manufactured by Mitsubishi Engineering-Plastics Corporation) was extruded from the T-die 12 in a non-dried state. The extruded film was nipped between the molding roll 13 and the elastic roll 14, and allowed to wrap around the molding roll 13. The preset value of the surface temperature of the molding roll 13 was adjusted to Tg+35° C., and the preset value of the surface temperature of the elastic roll 14 was adjusted to 75° C.

The sheet was then separated from the molding roll 13 with the aid of the cooling roll 15. The preset value of the surface temperature of the cooling roll 15 was adjusted to 115° C. The rotational speed of a take-up winder was adjusted to 7 m/min. In this way, the optical film of 220 μm thick, having the grooves formed on one main surface thereof, was obtained.

The surface temperature of the molding roll 13 and the elastic roll 14 was measured by allowing a sensor to contact with each of the surfaces of these rolls, at a position just before the nipping begins, which is less susceptible to heat of the resin. The surface temperature of the cooling roll 15 was measured by allowing a sensor to contact with the surface of the cooling roll 15, at a position of nipping of the film between the cooling roll 15 and the molding roll 13. The thermometer used herein was a handy-type digital thermometer (manufactured by CHINO Corporation, trade name: ND511-KHN), and the sensor used herein was a surface temperature measuring sensor (manufactured by Anritsu Meter Co., Ltd., trade name: U-161K-00-D0-1).

### Example 2

The optical film was obtained in a similar manner to Example 1 above, only except that the preset value of the surface temperature of the molding roll 13 was adjusted to Tg+20° C.

### Example 3

The optical film was obtained in a similar manner to Example 1 above, only except that the preset value of the surface temperature of the molding roll 13 was adjusted to Tg+45° C.

### Comparative Example 1

The optical film was obtained in a similar manner to Example 1 above, only except that the preset value of the surface temperature of the molding roll 13 was adjusted to Tg+50° C.

### Comparative Example 2

The optical film was obtained in a similar manner to Example 1 above, only except that the preset value of the surface temperature of the molding roll 13 was adjusted to Tg+15° C.

### Example 4

The optical film was obtained in a similar manner to Example 1 above, only except that the preset value of the surface temperature of the elastic roll 14 was adjusted to 20° C.

### Example 5

The optical film was obtained in a similar manner to Example 1 above, only except that the preset value of the surface temperature of the elastic roll 14 was adjusted to Tg-10° C.

### Comparative Example 3

The optical film was obtained in a similar manner to Example 1 above, only except that the preset value of the surface temperature of the elastic roll 14 was adjusted to 10° C.

### Comparative Example 4

The optical film was obtained in a similar manner to Example 1 above, only except that the preset value of the surface temperature of the elastic roll 14 was adjusted to Tg+10° C.

### Example 6

The optical film was obtained in a similar manner to Example 1 above, only except that the molding roll 13 and the cooling roll 15 were disposed a predetermined distance apart from each other, and the optical film was separated under non-contactness between the molding roll 13 and the cooling roll 15.

### Example 7

The optical film was obtained in a similar manner to Example 1 above, only except that the guide roll 16 was used in place of the cooling roll 15, so that the film was allowed to travel around the elastic roll 14, and was then separated between the elastic roll 14 and the guide roll 16.

### Comparative Example 5

The optical film was obtained in a similar manner to Example 1 above, only except that the preset value of the surface temperature of the cooling roll 15 was adjusted to Tg+10° C.

Transferability, mold releasability and flatness of thus-obtained optical films in Examples 1 to 7 and Comparative Examples 1 to 5 were then evaluated. Table 1 shows results of the evaluation of transferability, mold releasability and flatness of thus-obtained optical films in Examples 1 to 7 and Comparative Examples 1 to 5.

TABLE 1

| | Molding | Elastic | Cooling | Roll | | | |
|---|---|---|---|---|---|---|---|
| | Roll | Roll | Roll | Type | Transferability | Releasability | Waviness |
| Example 1 | Tg + 35° C. | 75° C. | 115° C. | Type 1 | ∘ | ∘ | ∘ |
| Example 2 | Tg + 20° C. | 75° C. | 115° C. | Type 1 | ∘ | ∘ | ∘ |
| Example 3 | Tg + 45° C. | 75° C. | 115° C. | Type 1 | ∘ | ∘ | ∘ |
| Comparative | Tg + 50° C. | 75° C. | 115° C. | Type 1 | Δ | x | x |
| Example 1 | | | | | | | |
| Comparative | Tg + 15° C. | 75° C. | 115° C. | Type 1 | Δ | x | x |
| Example 2 | | | | | | | |
| Example 4 | Tg + 35° C. | 20° C. | 115° C. | Type 1 | ∘ | ∘ | ∘ |
| Example 5 | Tg + 35° C. | Tg − 10° C. | 115° C. | Type 1 | ∘ | ∘ | ∘ |
| Comparative | Tg + 35° C. | 10° C. | 115° C. | Type 1 | ∘ | ∘ | Δ |
| Example 3 | | | | | | | |
| Comparative | Tg + 35° C. | Tg + 10° C. | 115° C. | Type 1 | ∘ | x | x |
| Example 4 | | | | | | | |
| Example 6 | Tg + 35° C. | 75° C. | 115° C. | Type 2 | ∘ | Δ | x |
| Example 7 | Tg + 35° C. | 75° C. | . . . | Type 3 | ∘ | ∘ | Δ |
| Comparative | Tg + 35° C. | 75° C. | Tg + 10° C. | Type 1 | ∘ | x | x |
| Example 5 | | | | | | | |

Paragraphs below will specifically describe how to evaluate the transferability, mold releasability and flatness of the optical films.

[Evaluation of Transferability onto Film]

The height of the lens components of the optical films obtained in Examples and Comparative Examples was measured using a roughness gauge (SJ201) manufactured by Mitutoyo Corporation. Transferability ratio was calculated as the height h of the lens component on the optical film relative to the depth d of the groove formed on the molding roll 13, wherein the transferability ratio is defined as 100% when thus-measured height h of the lens component on the optical films equals to the depth d of the groove formed on the molding roll 13. More specifically, the transferability ratio was calculated by:
transferability ratio=(h/d)×100.
Based on thus-calculated values of the transferability ratio, transferability of the films was evaluated according to judgment criteria below:

∘: transferability ratio of 90% or more;

Δ: transferability ratio of less than 90% and 70% or above; and

x: transferability ratio of less than 70%.

[Evaluation of Releasability of Film]

Degraded separation (mold releasing property) of the optical film results in production of separation-failure mark (mold-releasing-failure mark) on the optical film. Whether the separation-failure mark was produced or not on the optical film obtained in the Examples and Comparative Examples was visually judged, and based on the judgment, the mold releasability was evaluated according to judgment criteria below:

∘: no separation-failure mark observed;

Δ: slight separation-failure mark observed (small influence on optical characteristics); and

x: distinguished separation-failure mark observed (large influence on optical characteristics).

[Evaluation of Flatness of Film]

Linear light was irradiated on the optical films, whether distortion is observed in the reflected linear light or not is judged, and based on the judgment, the flatness was evaluated according to judgment criteria below:

∘: no waviness (distortion) observed;

Δ: slight waviness (distortion) observed (small influence on optical characteristics); and

x: large waviness (distortion) observed (large influence on optical characteristics).

Table 1 teaches the followings.

Desirable levels of the transferability and the mold releasability can be achieved at the same time, and further desirable flatness can be obtained, by adjusting the preset value of the surface temperature of the molding roll 13 within the range from Tg+20° C. or more and Tg+45° C. or less, by adjusting the preset value of the surface temperature of the elastic roll 14 within the range from 20° C. or above and Tg or below, and by adjusting the preset value of the surface temperature of the cooling roll 15 to Tg or below.

The embodiments have specifically been described, however, the description is not for limiting the present invention at all, allowing instead various modifications based on the technical spirit of this invention.

For example, any numerical values exemplified in the above-described Examples are merely for exemplary purposes, and adoption of any different numerical values is allowable.

The above-described Examples explained the case where the toroidal lens components were provided on the optical sheet 1, wherein the geometry of the lens components is by no means limited to the examples, typically allowing instead provision of triangle prisms or the like on the optical sheet.

The above-described Examples explained the case where the surface on the side of incidence of light from a light source is a flat surface, whereas this surface may be provided with various irregular geometries or projections of a predetermined roughness by texturing. It is therefore made possible to prevent recognition of a dot pattern of a light guide plate, non-uniformity in the light from the light source possibly produced between the optical film and the light guide plate, and generation of interfered light. The textured surface can preferably be formed by transferring a texture, preliminarily formed on the surface of the elastic roll, onto the film. This process allows formation of the lens surface and the textured surface at the same time.

It should be understood by those skilled in the art that various modifications, combinations, sub-combinations and alterations may occur depending on design requirements and other factors insofar as they are within the scope of the appended claims or the equivalents thereof.

The invention is claimed as follows:

1. A method of fabricating an optical film, comprising:
nipping a film composed of a molten polycarbonate resin extruded in a film-forming manner from a die attached to an extruder, between a temperature-preset molding roll having an engraving pattern on the surface thereof and a temperature-preset elastic roll, and thereby transferring the engraving pattern onto the film; and
allowing the film having the engraving pattern transferred thereon to travel around the molding roll, and then separating the film from the molding roll, wherein:
a preset value of a surface temperature of the molding roll is adjusted within a range of 20° C. to 45° C. above a glass transition temperature the glass transition temperature of the film, and a preset value of a surface temperature of the elastic roll is adjusted to the glass transition temperature or below.

2. The method of fabricating an optical film according to claim 1, wherein the film is separated between the molding roll and a temperature-preset cooling roll in contact with the molding roll while placing the film in between; and
a preset value of a surface temperature of the cooling roll is adjusted to the glass transition temperature or below.

3. The method of fabricating an optical film according to claim 1, wherein the film is separated between the molding roll and a temperature-preset cooling roll kept in non-contact with the molding roll, and
a preset value of a surface temperature of the cooling roll is adjusted to the glass transition temperature or below.

4. The method of fabricating an optical film according to claim 1, wherein the temperature of the film in the process of separation thereof from the molding roll is adjusted within a range of 20° C. to 45° C. above the glass transition temperature.

5. A method of fabricating an optical film, comprising:
nipping a film composed of a molten polycarbonate resin extruded in a film-forming manner from a die attached to an extruder, between a temperature-preset molding roll having an engraving pattern on the surface thereof and a temperature-preset elastic roll, and thereby transferring the engraving pattern onto the film; and
allowing the film having the engraving pattern transferred thereon to travel around the elastic roll, and then separating said film from said elastic roll, wherein:
a preset value of a surface temperature of the molding roll is adjusted within a range of 20° C. to 45° C. above a glass transition temperature of the film the glass transition temperature, and a preset value of a surface temperature of the elastic roll is adjusted to the glass transition temperature or below.

6. The method of fabricating an optical film according to claim 5, wherein the film is separated between the elastic roll and a guide roll disposed a predetermined distance apart from the elastic roll.
